(19) United States
(12) Patent Application Publication
(10) Pub. No.: US 2016/0147836 A1
(43) Pub. Date: May 26, 2016

(54) Enhanced Network Data Sharing and Acquisition

(71) Applicant: Tencent Technology (Shenzhen) Company Limited, Guangdong (CN)

(72) Inventor: Gang Liu, Shenzhen (CN)

(21) Appl. No.: 14/891,928

(22) PCT Filed: Jul. 18, 2014
(86) PCT No.: PCT/CN2014/082461

§ 371 Date: Nov. 17, 2015

(30) Foreign Application Priority Data
Jul. 22, 2013 (CN) 201310309343.1

(51) Int. Cl. G06F 17/30; H04L 29/06; G06F 17/22

(52) U.S. Cl. CPC G06F 17/30477; G06F 17/2235; H04L 65/403

(57) ABSTRACT

An enhanced network resources sharing and acquisition is presented to users in on digital data sharing environment. A client device of a user requesting for sharing a digital data resource identified by the user, e.g., a video file, with other users detects the user request and obtains a digital image associated with the digital data resource. The digital data resource is identified by corresponding address information. The client device processes the digital image associated with the digital data resource by embedding the address information into the digital image using digital content embedding techniques such as digital watermarking. The client device uploads the processed digital image to a data sharing platform for sharing. Other users in the data sharing environment retrieve the address information of the digital data resource from the digital image and access the digital data resource using the address information.

### TECHNICAL FIELD

The disclosure relates generally to the field of Internet based network communications, and specifically to enhanced network data sharing and acquisition.

### BACKGROUND

The development of digital media content sharing and Internet social networking has enabled many features to enhance the user experience. However, the proliferation of digital media hosting sites that allow users to upload digital content (e.g., music content and video content) for mass viewing has highlighted a number of challenges including efficient sharing and acquisition of network resources. Network resources generally refer to digital data resources stored on the Internet for users to download and share. Network resources may include computer program files, video files, audio files, text and combinations of various types of network resources. When a user recommends his/her favorite network resources to other users, the user can acquire a download link of the network resources and share the network resources with other users who access and download the network resources through the download link.

Existing download solutions provide a Uniform Resource Locator (URL) of the network resource to he downloaded as the download link. For example, Hypertext Transfer Protocol (HTTP) of a website hosting the network resource provides a URI, link to the network resource. Other examples include the eMule protocol which provides a link to the network resource through a file sharing network, e.g., eDankey2000network (ed2k), and BitComet (BT) protocol which uses a BT seed to link to the network resource. However, for trimly websites hosted on the Internet, a download link often uses special characters that can be filtered to limit transmission scope of the network resources identified by the download link. Moreover, in many websites, seed files that provide links to network resources cannot be directly uploaded to a sharing forum or can be uploaded only at high cost. For example, if the network resource identified by a seed file is requested, the original seed file needs to be compressed into a data container file, e.g., RAR tile, or plug-in that supports the seed file by the sharing forum is often required.

Another problem associated with existing download solutions is lack of knowledge the network resources, e.g., quality of a movie to be downloaded, when sharing download links to network resources. For example, a video file to be downloaded from a download link is often marked as having DVD or high visual quality. But the actual quality of the video file after download is often worse than the proclaimed quality due to many factors such as degradation due to network conditions.

### SUMMARY

Embodiments of the invention provide enhanced network data sharing and acquisition by embedding address information of digital data resources to be shared in digital images associated with the digital data resources. Using digital images of the digital data resources embedding network address of the digital data resources improves the performance of digital data resources downloading by efficiently sharing the network address of the digital data resources to be downloaded.

A computer-implemented method for sharing network resources among multiple clients is disclosed. Embodiments of the method comprise detecting a request from a client for sharing a digital data resource, e.g., a video file, and obtaining a digital image associated with the digital data resource. Examples of digital images associated with a digital data resource include video frames of the digital data resource and images generated from one or more screenshots of the digital data resource. The embodiments of the method also comprise processing the digital image associated with the network resource by embedding address information of the digital data resource in the digital image. The address information of the digital data resource can be embedded into the digital image by digital watermarking and use of data storage capacity in images in Exchangeable image file format. The processed digital image is uploaded to a data sharing platform for sharing, where other clients retrieve address information of the digital data resource from the digital image and access the digital data resource using the address information.

Another aspect provides a client device for sharing digital data resources among multiple clients. One embodiment of the client device has a computer processor for executing computer program modules such as a resource sharing module and a resource acquisition module and a non-transitory computer readable storage device storing computer program modules. The computer program modules are executable to perform steps comprising detecting a request from a client for sharing a digital data resource identified by the client and obtaining a digital image associated with the digital data resource. The client device is configured to process the digital image associated with the digital data resource by embedding address information of the digital data resource in the digital image. The processed digital image is uploaded to a data sharing platform for sharing, where other clients retrieve address information of the digital data resource from the digital image and access the digital data resource using the address information.

Another aspect provides a non-transitory computer-readable storage medium storing executable computer program instructions for sharing digital data resources among multiple clients. The computer-readable storage medium stores computer program instructions for detecting a request from a client for sharing a digital data resource identified by the client and obtaining a digital image associated with the digital data resource. The computer-readable storage medium further stores computer program instructions for processing the digital image associated with the digital data resource by embedding address information of the digital data resource in the digital image, The processed digital image is uploaded to a data sharing platform for sharing, where other clients retrieve address information of the digital data resource from the digital image and access the digital data resource using the address information.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

FIG. 1 is a block diagram of a computing environment for supporting enhanced sharing and acquisition of network resources according to one embodiment.

FIG. 2 is a block diagram illustrating an example of a computer for acting as a client device and/or data sharing server in one embodiment.

FIG. 3 is a block diagram illustrating a client device according to one embodiment.

FIG. 4 is a block diagram illustrating a resource sharing module according to one embodiment.

FIG. 5 is a block diagram illustrating an image acquisition module according to one embodiment.

FIG. 6 is a block diagram illustrating a resource acquisition module according to one embodiment.

FIG. 7 is a block diagram illustrating an example of a data service module in one embodiment.

FIG. 8 is a flowchart illustrating a process for generating digital images that embed network address of network resources for sharing according to one embodiment.

FIG. 9 is a flowchart illustrating a process for acquiring network resources according to one embodiment.

FIG. 10 is a flowchart illustrating a process for acquiring requested images that embed network address of network resources for sharing according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made a detail to several embodiments, examples of which are illustrated in the accompanying figures. It is noted that wherever practicable similar or like reference numbers may be used in the figures to indicate similar or like functionality.

### SYSTEM OVERVIEW

A solution to efficient sharing and acquiring of network resources described above is an enhanced data sharing system that generates digital images associated with network resources, where the digital images embed network address information such as download links of die network resources for sharing. Compared with existing solutions, the enhanced data sharing system provides a new channel for sharing network resources by using digital images associated with the network resources. The digital images of the network resources embed network address of the network resources for sharing and the digital images can be used as download access points. Using digital images of the network resources embedding network address of the network resources improves the performance of network resources downloading by securely and efficiently sharing the network address of the network resources to be downloaded.

Additional advantages provided by the enhanced data sharing system include a prior knowledge of quality of network resources before downloading the network resources, Users who intend to download a video file can preview sample digital images of the video file to evaluate the quality of the video file before downloading the video file. The enhanced data sharing system also improves network resources sharing efficiency. For example, for a BT protocol based communication system, the enhanced data sharing system can embed BT seeds in digital images of the network resources for sharing. Users can retrieve the download links provided by the BT seeds from the digital images associated with the network resources.

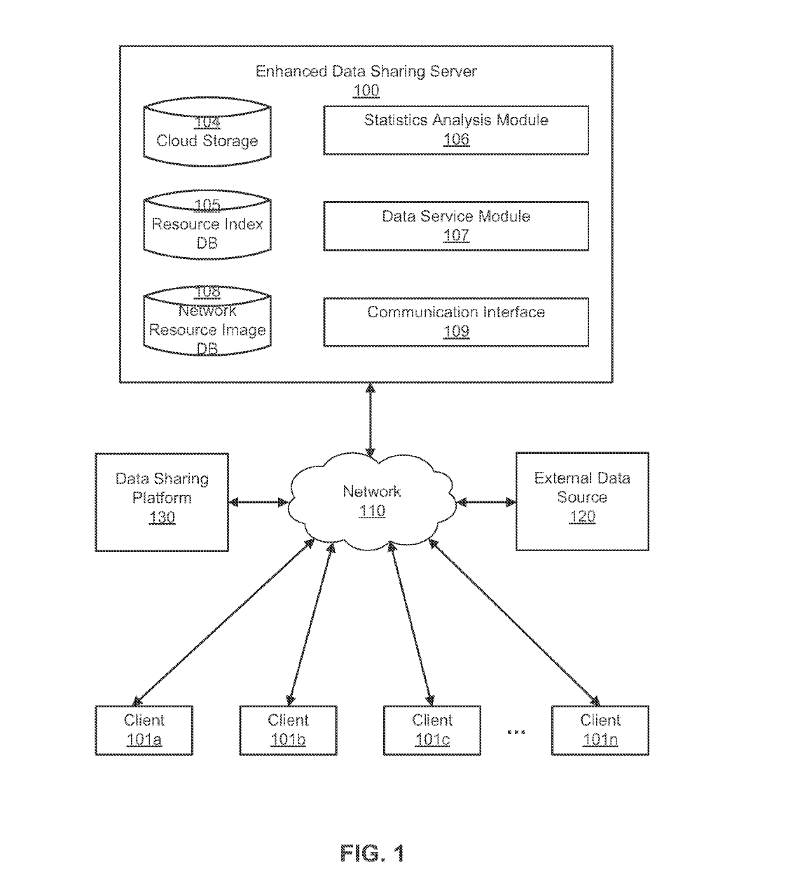

FIG. 1 shows a computing environment for supporting enhanced network resources sharing and acquisition according to one embodiment. The computing environment includes an enhanced data sharing server 100, a plurality of client devices 101a-101n, a data sharing platform 130 and an external data source 120 connected by a network 110. Only one data sharing server 100, four client devices 101, one data sharing platform 130 and one external data source 120 are shown in FIG. 1 in order to simplify and clarify the description. Embodiments of the computing environment can have many data sharing servers 100, client devices 101, data sharing platforms 130 and external data sources 120 connected to the network 110. Likewise, the functions performed by the various entities of FIG. 1 may differ in different embodiments.

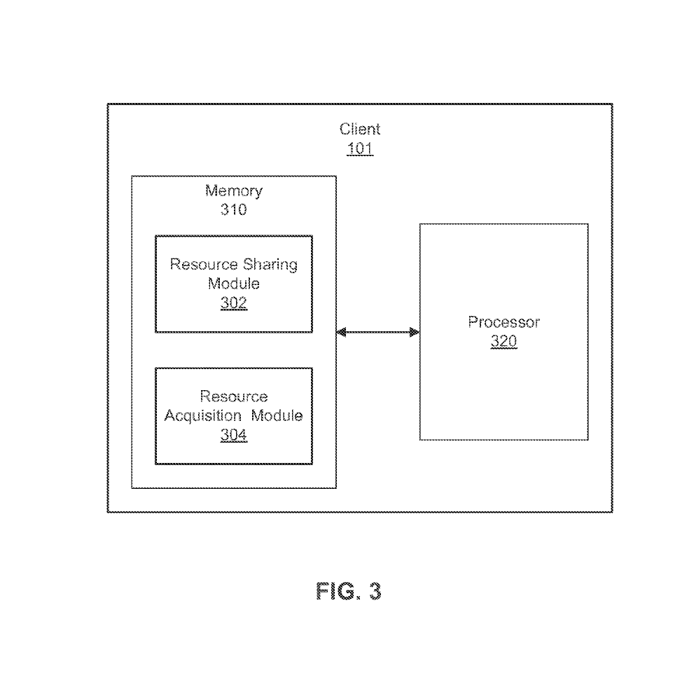

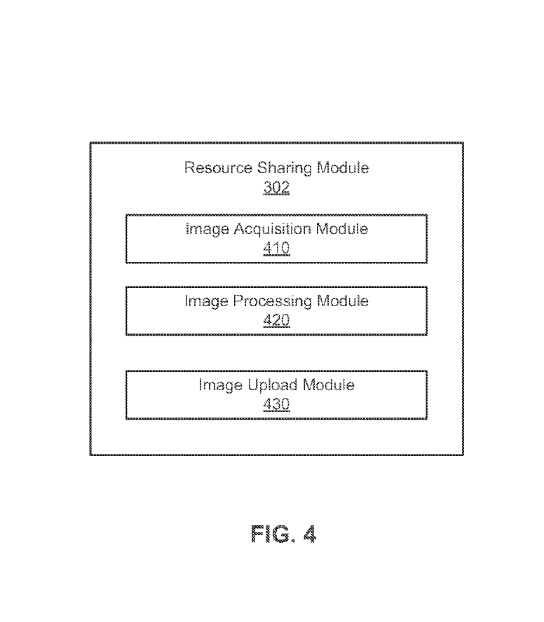

In one embodiment, a user of the client device 101 wants to share a network resource, e.g., a video file of an episode of the user's favorite TV show, with other users of the data sharing platform 130, e.g., Tencent WeiBo™. The client device 101 generates, by a resource sharing module and a resource acquisition module (as shown in FIG. 3), one or more digital images associated with the network resources to be shared. The digital images embed the network address of the network resources, e.g., download links of the network resources. The client device 101 uploads the digital images associated with the network resources to the data sharing platform 130, where other users access and download the network resource located at the network address identified by the address information embedded in the digital images. The client device 101 is further described below with reference to FIG. 3. The resource sharing module and the resource acquisition module of the client device 101 are further described below with reference to FIGS. 4-6 and FIGS. 8-10.

In another embodiment, the data sharing server 100 generates digital images that embed address information of network resources for sharing and stores the digital images associated with the network resources in a storage repository (e.g., cloud storage 104) of the data sharing server 100. The data sharing server 100 communicates with the data sharing platform 130 through a communication interface. Responsive to a user request for sharing a network resource, e.g., a TV show, with other users, the data sharing server 100 searches for the requested network resource based on the address information associated with the network resource and serves the user request by enabling the downloading of the requested network resources by other users.

In one embodiment, the data sharing server 100 includes a statistics analysis module 106, a data service module 107, a communication interface 109, a cloud storage 104, a resource index database 105 and a network resource image database 108. Other embodiments of the data sharing server 100 include different and/or additional components. In addition, the functions may be distributed among the components in a different manner than described herein.

The cloud storage 104 stores network resources, e.g., a large amount of video files, which can be downloaded by users of the clients 101 via a cloud network. in one embodiment, the cloud storage 104 stores network resources accumulated by the data serving server 100. In another embodiment, the cloud storage 104 stores network resources uploaded by the users of the clients 101. Alternatively, the network resources can be stored in the external data source 120 described below.

The resource index database 105 stores index information associated with network resources. The index information can be used by the data sharing server 100 to retrieve address information of requested network resources. In one embodiment, the URL of a network resource is used as the index for the network resource. The network resource can be identified by a hash value associated with the network resource, e.g., a hash of the file ID of the network resource. If a network resource is identified by its corresponding hash value, the URL, of the network resource is associated with the hash value of the network resource. The resource index database 105 may also store validity checking information associated with a part of the network resource, e.g., a file fragment, A client 101 can use the validity checking information associated with the network resources to verify the downloaded content of the network resources.

The network resource image database 108 stores digital images (also referred to as “images”) associated with network resources for sharing and the images embed address information for accessing the network resources. In one embodiment, the images of network resources are one or more key frames extracted from video files acquired by the data sharing server 100 and the extracted key frames are processed to embed network address information of the corresponding video files. Taking BT protocol in a peer-to-peer (P2P) and peer-to-server-and-peer (P2sP) communication system as an example, a BT seed of the BT protocol often includes a poster for a video fife. The images of the video tile are one or more video frames extracted from the poster for the video file. In another embodiment, the images of network resources are extracted from the network resources generated from one or more screenshots of the network resources.

In one embodiment, the network resource image database 108 also stores preview information associated with the network resources. The preview information associated with a network resource, e.g., a video file, includes file size of the network resource, file name, average download speed of the network resource, resolution of a video file, author of a music album, any mark/logo of a publisher of the network resource and any other information describing the network resource. The preview information associated with a network resource can be reviewed by a client 101 downloading the network resource, In one embodiment, the preview information can be embedded into a digital image of the network resource in addition to the address information of the network resource. Embedding address information in a digital image associated with a network resource is further described below with reference to FIGS. 4-6 and FIGS. 8-10.

The statistics analysis module 106 analyzes information associated with network resources downloaded by the clients 101a-n. In one embodiment, the statistics analysis module 106 monitors file downloading by the clients 101a-n and collects information associated with the file downloading. The information associated with the file downloading includes download speed, download time, network connectivity, download result, file size of the downloaded network resource and any other information describing the file downloading. The statistics analysis module 106 analyzes the collected information and interacts with other modules of the data sharing server 100, e.g., data service module 107 and communication interface 109, which use the file downloading statistics to adjust corresponding network resources sharing operations.

The communication interface module 109 provides an interface between the clients 101a-n and the data sharing server 100. In one embodiment, the communication interface module 109 receives network resources uploaded by the client 101a-n and stores the network resources in the digital data database 108 and/or cloud storage 104. In another embodiment, the communication interface module 109 receives digital images associated with network resources that embed network address of the network resources for sharing, and provides the digital images to the intended clients 101.

The data service module 107 provides digital images associated with requested network resources for sharing and embeds network address of the network resources in the digital images. In one embodiment, the data service module 107 includes a resource sharing module and a resource acquisition module similar as the corresponding modules of the clients 101. Providing digital images associated with network resources as downloading entries on the data sharing server 100 side allows clients 101 to access the network resources that are not stored locally with the clients 101.

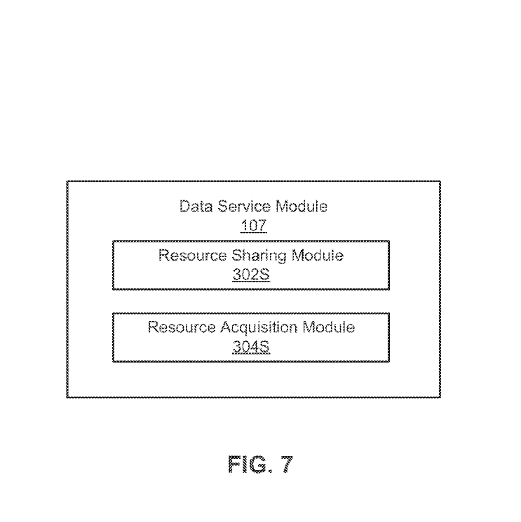

Further, providing digital images associated with network resources as downloading entries on the data sharing server 100 side allows the data sharing server 100 to process the network resources offline for efficient system performance, For example, responsive to clients' displaying capabilities and network conditions, the data service module 107 processes the network resources uploaded by clients 101, e.g., transcoding the uploaded video files to have an appropriate display resolution to be displayed on display devices of the clients 101. The data service module 107 is further described below with reference to FIG. 7.

The data sharing platform 130 provides an interface and a data sharing environment for users of the clients 101a-n to share network resources. In one embodiment, the data sharing environment provided by the data sharing platform 130 is a microblogging site, e.g., Tencent WeiBo™ which allows users to share multimedia files, e.g., digital images, music and videos files. Other data sharing environments, e.g., electronic mailing systems, instant messaging systems, online chatting/forums, group communications and virtual space, are also available for implementing the data sharing platform 130. The data sharing platform 130 also performs operations associated with the data sharing environment, e.g., registering a user into an online chat room and verifying group membership for an online group community.

The data sharing platform 130 also provides an interface (not shown in FIG. 1) for users of the clients 101a-n to share network resources. In one embodiment, the interface of the data sharing platform 130 receives content of network resources uploaded to the data sharing platform for sharing and distributes the network resources to the intended clients 101. Responsive to video files to be shared, the interface of the data sharing platform 130 interacts with the data sharing server 100 to obtain the requested video files from the data storage of the data sharing server 100 and provides the received video files to the intended clients 101.

The external data source 120 includes one or more data storage devices that store network resources for downloading. In one embodiment, the external data source 120 includes one or more web servers that support one or more websites that host the content of the network resources.

The external data source 120 may additionally store information related to the network resources such as online databases describing entities referenced in the network resources (e.g., characters in movies and/or novels.)

The network 110 enables communications among the data sharing server 100, client devices 101a-n, the data sharing platform 130 and the external data source 120 and can comprise the Internet. In one embodiment, the network 110 uses standard communications technologies and/or protocols such as BT protocol in a P2P and P2sP communication system. In another embodiment, the entities can use custom and/or dedicated data communications technologies instead of, or in addition to, the ones described above.

A client device 101 is an electronic device used by a user to perform functions such as downloading and consuming digital content of network resources including watching videos, executing software applications, browsing websites hosted by web servers on the network 110 and interacting with the data sharing server 100. For example, the client device 101 may be a dedicated video player, a smart phone, or a tablet, notebook, or desktop computer. The client device 101 includes and/or interfaces with a display device on which the user may view the video files and other digital content. In addition, the client device 101 provides a user interface (UI), such as physical and/or on-screen buttons, with which the user may interact with the client device 101 to perform functions such as consuming digital content, selecting digital content, downloading samples of digital content, and purchasing digital content, An exemplary client device 101 is described in more detail below with reference to FIG. 3.

### COMPUTING SYSTEM ARCHITECTURE

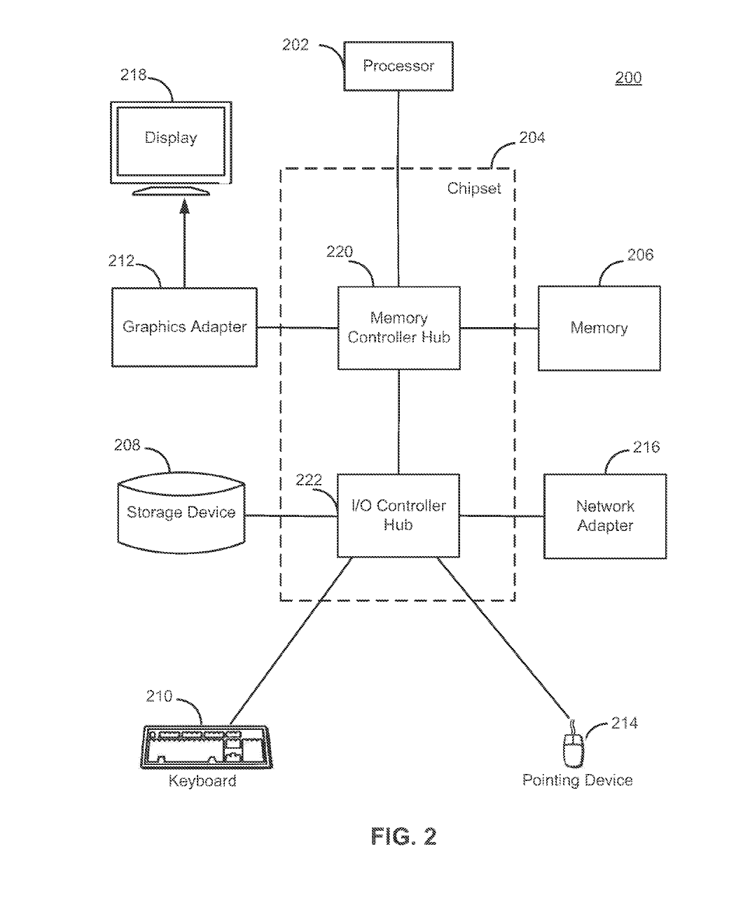

The entities shown in FIG, 1 are implemented using one or more computers. FIG. 2 is a high-level block diagram of a computer 200 for acting as the data sharing server 100, the external data source 120, data sharing platform 130 and/or a client device 101 a-n. Illustrated are at least one processor 202 coupled to a chipset 204. Also coupled to the chipset 204 are a memory 206, a storage device 208, a keyboard 210, a graphics adapter 212, a pointing device 214, and a network adapter 216. A display 218 is coupled to the graphics adapter 212. In one embodiment, the functionality of the chipset 204 is provided by a memory controller hub 220 and an I/O controller hub 222. In another embodiment, the memory 206 is coupled directly to the processor 202 instead of the chipset 204.

The storage device 208 is any non-transitory computer-readable storage medium, such as a hard drive, compact disk read-only memory (CD-ROM), DVD, or a solid-state memory device. The memory 206 holds instructions and data, used by the processor 202. The pointing device 214 may be a mouse, track ball, or other type of pointing device, and is used in combination with the keyboard 210 to input data into the computer system 200. The graphics adapter 212 displays images and other information on the display 218. The network adapter 216 couples the computer system 200 to the network 110.

As is known in the art, a computer 200 can have different and/or other components than those shown in FIG. 2. In addition, the computer 200 can lack certain illustrated components. For example, the computers acting as the data sharing server 100 can be formed of multiple blade servers linked together into one or more distributed systems and lack components such as keyboards and displays. Moreover, the storage device 208 can be local and/or remote from the computer 200 (such as embodied within a storage area network (SAN)).

As is known in the art, the computer 200 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 208, loaded into the memory 206, and executed by the processor 202.

### NETWORK RESOURCE SHARING AND ACQUIRING

FIG. 3 is a block diagram illustrating an example of a client device 101 for acquiring network resources and sharing network resources in one embodiment. A user of the client device 101 sends a request for sharing a network resource, a video tile. The client device 101 detects the request and acquires one or more images associated with the network resource. The client device 101 also acquires the network address of the network resource, e.g., a URL of the web server that hosts the network resource, and embeds the network address into the images associates with the network resource. The client device 101 uploads the processed images that embed the network address of the network resource to a data sharing platform for other users to access the network resource.

In the embodiment shown in FIG. 3, the client device 101 has a computer memory 310 and a computer processor 320. The memory 310 stores data and/or instructions that may be executed by the processor 320. The instructions may comprise computer program code for performing any and/or all of the techniques described herein, The memory 310 may be a DRAM device, a static random access memory (SRAM), Flash RAM (non-volatile storage), combinations of the above, or some other memory device known in the art. In one embodiment, the memory 310 comprises a resource sharing module 302 and a resource acquisition module 304. Other embodiments may contain different functional modules and different number of modules.

FIG. 4 is a. block diagram illustrating a resource sharing module 302 according to one embodiment. The resource sharing module 302 obtains images associated with network resources and address information of the network resources. The resource sharing module 302 adds the address information of the network resources to the corresponding images associated with the network resources and uploads the processed images to a data sharing platform for sharing.

In one embodiment, the resource sharing module 302 includes an image acquisition module 410, an image processing module 420 and an image upload module 430. The image acquisition module 410 obtains images associated to network resources and address information of the network resources in response to detecting a user request for sharing the network resources. Examples of the images associated with the network resource to be shared include TV poster Of movie trailer or images extracted from the video Ides. In one embodiment, the image acquisition module 410 obtains the images of the network resources directly from local storage of the clients 110, which request the network resources for sharing. In another embodiment, the image acquisition module 410 obtains the images of the network resources from a remote storage, e.g., the cloud storage 104 of the data sharing server 100 illustrated in FIG. 1.

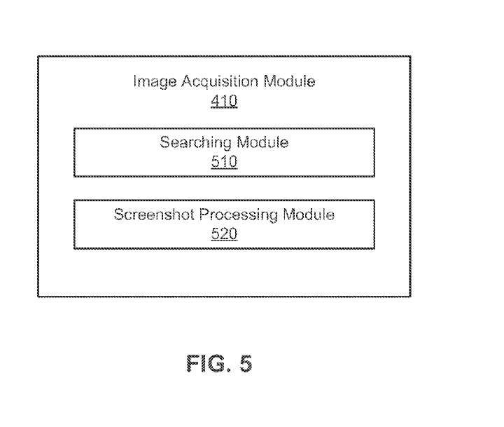

Referring to FIG. 5, one embodiment of the image acquisition module 410 includes a searching module 510 and a screenshot processing module 520, The searching module 510 searches for images associated with network resources upon a user request. For example, responsive to detecting a user of a client 101 requesting to share a network resource, e.g., a video file of his/her favorite TV show, the searching module 4510 searches various storage repositories for the images of the requested network resource. In one embodiment, the searching module 510 searches the local storage of the client 101 for the requested images of the network resource. If the images of the network resource are found in the local storage, the searching module 510 retrieves the images associated with the network resources directly from the local storage.

In another embodiment, the searching module 510 searches remote storage for the images of the requested network resource. For example, the searching module 510 searches the cloud storage 104 of the data sharing server 100 illustrated in FIG. 1. Upon finding the images of the requested network resource in the cloud storage 104, the searching module 510 retrieves the images, The searching module 510 may conduct the local storage search and remote storage search in parallel or in sequence, e.g., searching the remote storage following the local storage search,

The screenshot processing module 510 interacts with the searching module 510 to take screenshots of the requested network resource, e.g., digital images of the network resource captured at various time points, and generate images associated with the requested network resource from the screenshots. In one embodiment, the screenshot processing module 520 generates images of network resources from screenshots of the network resources upon request. The network resources for sharing sometimes do not have corresponding images ready for retrieval by the searching module 510 either from a local storage or from a remote storage. In such a case, the searching module 510 instructs the screenshot processing module 520 to take screenshots of the requested network resource stored in a local storage or in a remote storage and generate images from the screenshots. in another embodiment, the screenshot processing module 520 automatically takes screenshots and generates images upon a network resource downloaded by a client 101.

The screenshot processing module 520 may take screenshots of a requested network resources in various ways. Taking a video file as an example, the screenshot processing module 520 may take screenshots of the head, middle and tail images of the video file in accordance with different durations of the video file. For example, for an hour long video, the screenshot processing module 520 may take screenshots of the video at time points of 10 minutes, 30 minutes and 50 minutes. Given that the head and the tail of a video file generally contain caption and word introduction information, the screenshot processing module 520 calculates the average brightness of each pixel of a screenshot. If the average brightness of screenshot is tower than a predetermined threshold., the screenshot is likely a screenshot of the head or tail of the video file and the screenshot is ignored. The screenshot processing module 420 adjusts time points to take additional screenshots. Taking a computer program file as an anther example, the screenshot processing module 520 selectively takes screenshots of key operating interfaces of the program file.

In addition to obtain images of network resource to be shared, the image acquisition module 410 obtains address information of the network resources. The address information of a network resource identifies an access point to the network resource on the Internet In one embodiment, the address information of the network resources comprises download links, link identifiers represented by hash values and file check information of the network resources. For example, responsive to a user of the client 101 downloading a network resource to be shared from a website that hosts the network resource, the original download link of the network resource from the website is stored locally in the client 101. The image acquisition module 410 obtains the original download link as the corresponding address information of the requested network resource from the local storage of the client 101.

The image acquisition module 410 retrieves additional information associated with the address information of a network resource. For example, the image acquisition module 410 retrieves an index of resources associated with the network resource, the hash value and the file verification information of the network resource. The image acquisition module 410 receives the index of resources either from the corresponding website having the URL address of the network resource or from the resource index database 105 of the data sharing server 100.

Referring back to FIG. 4, the image processing module 420 of the resource sharing module 302 receives images and address information obtained by the image acquisition module 420 and adds the address information into the images. The images processed by the image processing made 420 carries address information of the network resources to be shared in a way that the network resource access information can be shared in a secure way. Generally, images having larger amount of content data in terms of file size than images having less content data are preferred to embed address information of network resources because the address information embedded in images having larger amount of data are harder to detect by non-intended recipients, thus, more secure for sharing.

In one embodiment, the image processing module 420 adds the address information of a network resource to its corresponding images using digital watermarking. Digital watermarking generally refers to technologies of directly embed marking information (e.g., digital watermark) into a digital carrier (e.g., a video file) or modifying partial structure of the digital carrier (e.g., changing a specific region of a video frame). Digital watermarking a multimedia file does not degrade the visual quality of the multimedia and provides a way to hide important information inside the multimedia file itself, which can be verified by providers and intended recipients of the multimedia file. Two types of digital watermarking techniques, spatial digital watermarking and frequency based digital watermarking, can be used by the image processing module 420 to embed address information in an image of the network resource.

In one embodiment, the image processing module 420 embeds the address information (e.g., a URL link of the network resource) into an image of the network resource by spatial digital watermarking techniques. The image processing module 420 applies a Least Significant Bits (LSB) scheme to the image by modifying color information or bit planes representing the colors of the image. The image processing module 420 detects pixels that are not important based on the results of the LSB application to the image and adds the address information into the image using the detected pixels. For example, for a pixel in a 24-bit bitmap in an ROB (red-green-blue) color space, 8 bits are used to represent each of the three color components. Taking blue color representation of the image for example, different numerical values can be used to represent different shades of blue. For example, for the different shades of blue represented by binary numbers 11111111 and 11111110, it may be close to impossible to distinguish the two different blue shades with the human eyes. Thus, the least significant bits of each blue shade can be used to store information such as network address, where these changes to the image are undetectable to human eyes. If the same operations are performed on the red and the green colors, one byte of information can be stored in 3 pixels of the color components.

in another embodiment, the image processing module 420 uses a frequency based digital watermarking to embed the address information of a network resource. The image processing module 420 analyzes the image in time and frequency domains based on the spectrum of the signals representing the image. The image processing module 420 selects pixels that are the least sensitive to visual detection in the frequency domain and modifies the selected pixels to include the address information of a network resource.

As another example, the image processing module 420 may embed the address information into an image of the network resource in Exchangeable Image Files (Exif) format, Exif is a file format for images, whose data storage structure is the same as for JPEG files. Exif file format allows various information to be added to Exif extended fields of an image, including aperture, shutter, focal length of a camera taking the image, date, time, color code, voice recorded during image capturing, global position system (GPS) information and thumbnails. The image processing module 420 adds the address information of the network resource into an Exif extended field of the image in Exif format without modifying the resolution of the image.

Another embodiment of the image processing module 420 embeds the address information of network resources by attaching the address information to the tail of the images of the network resources without modifying original content of the images. For example, assuming that the image file of a network resource is called “A.JPG” and a compressed file of the address information of the network resource to be added in the image is called “B.ZIP” The image processing module 420 embeds the address information by generating a new image file, “C.JPG,” that is attached to the compressed file, “B.ZIP,” at the end of the original image file, “A.JPG.” The size of the new image file, “C.JPG,” is the sum of the size of “A.JP” and the size of “B.ZIP.”

The above discussion of images processed by the image processing module 420 focuses on images extracted from the network resources. However, the images described above can also include video frames from a poster for a video file downloaded by a client 101 through a BT seed file using BT protocol and images generated from screenshots of network resources, If the network resource to be shared is a multimedia file, preview information associated with the network resource such as author of a sound album, logo of a publisher and file validity checking information can also be embedded in the images of the network resources.

The image upload module 430 of the resource sharing module 302 uploads the images of network resources processed by the image processing module 420, In one embodiment, the image upload module 430 uploads the processed images to a data sharing platform, e.g., the data sharing platform 130 of the data sharing server 100, for sharing,. For example, the image upload module 430 sends the processed images through emails or instant messages to recipient clients 101, which process the images to retrieve address information of the network resources and access the network resources using the address information.

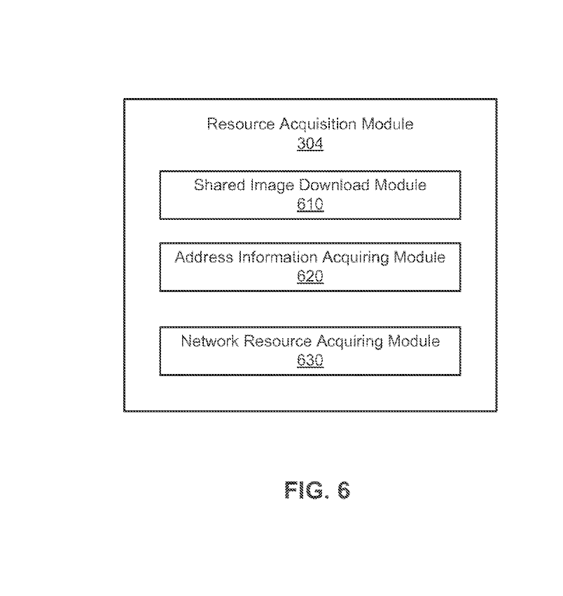

FIG. 6 is a block diagram illustrating a resource acquisition module 304 according to one embodiment. The resource acquisition module 304 obtains images that embed address information of corresponding network resources, retrieves network address information embedded in the images and acquire the network resources using the address information. In the embodiment illustrated in FIG. 6, the resource acquisition module 304 includes a shared image download module 610, an address information acquiring module 620 and a network resource acquiring module 630.

The resource acquisition module 304 obtains images that. embed address information of corresponding network resources. Responsive to a notification of images of network resources received by a client 101, e.g., an email or instant message, the resource acquisition module 304 of the client 101 sends a request for the images. An example request includes a mouse action of the client 101, e.g., right click to choose “Save Image As,” while the client reviewing the images.

Upon receiving the requested images, the address information acquiring module 620 analyzes the images and retrieves the address information of the network resources embedded in the images. In one embodiment, the address information acquiring module 620 retrieves the address information according to digital watermarking principles responsive to the images being processed using digital watermarking techniques. In another embodiment, the address information acquiring: module 620 retrieves the address information from the extended fields of Exif file responsive to the images in Exif format. In yet another embodiment, the address information acquiring module 620 retrieves the address information by segmenting an address information file from an image file that combines a file of an original image of the network resource and the address information file.

The network resource acquiring module 630 obtains the network resources using the corresponding address information retrieved by the address information acquiring module 620. In one embodiment, the network resource acquiring module 630 access the network resources at the location indicated by the corresponding address information and downloads the network resources from the identified location, e.g., the websites hosting the network resources and the websites identified by the address information (e.g., URLs of the websites).

To monitor the network resource downloading, the network resource acquiring module 630 creates a downloading task, which records the downloading performance, e.g., download speed and download result. Upon completing the network resource downloading, the network. resource acquiring module 630 notifies a tracking server (not shown in FIG. 4 and FIG. 1) of the data sharing server. The tracking server, in turn, notifies other clients that share the network resources such that the other clients may inquire the peers that have downloaded the network resources and start multi-source P2P download and data exchanges. Additionally, upon completing the network resource downloading, the network resource acquiring module 630 sends the statistics recorded in the downloading task to a statistics analysis module, e.g., the statistics analysis module 108 of the data sharing server 100, for analysis.

The enhanced network resources sharing and acquisition described above with reference to the client device 101 can also be performed at the data sharing server 100 side. Providing digital images associated with network resources as downloading entries on the data sharing server 100 side further enhances the user experience of network resources sharing. For example, when a client 101 gets booted up for the first time, the local storage of the client 101 likely has no network resources to share. In such a scenario, the data sharing server 100 side allows clients 101 to access the network resources that are not stored locally with the clients 101. Providing digital images associated with network resources as downloading entries on the data sharing server 100 side also allows the data sharing server 100 to process the network resources offline for efficient system performance such as video transcoding.

In one embodiment, the data sharing server 100 provides network resources sharing and acquisition functionalities through a data service module 107. FIG. 7 is a block diagram illustrating an example of data service module 107 in one embodiment. The embodiment of the data service module 107 in FIG. 7 includes a resource sharing module 302S and a resource acquisition module 304S. In one embodiment, the resource sharing module 302S and the resource acquisition module 304S provide the same functions as the resource sharing module 302 and the resource acquisition module 304 illustrated in FIG. 3.

In another embodiment, the resource sharing module 302S and the resource acquisition module 304S provide the similar functions as the resource sharing module 302 and the resource acquisition module 304 illustrated in FIG. 3. For example, an image acquisition module of the data service module 107 automatically takes screenshots and generates images upon a network resource stored in the data sharing server 100. Thus, the screenshot processing by the image acquisition module at the server side can be independent from the screenshot processing performed by the clients 101.

### EXEMPLARY METHOD

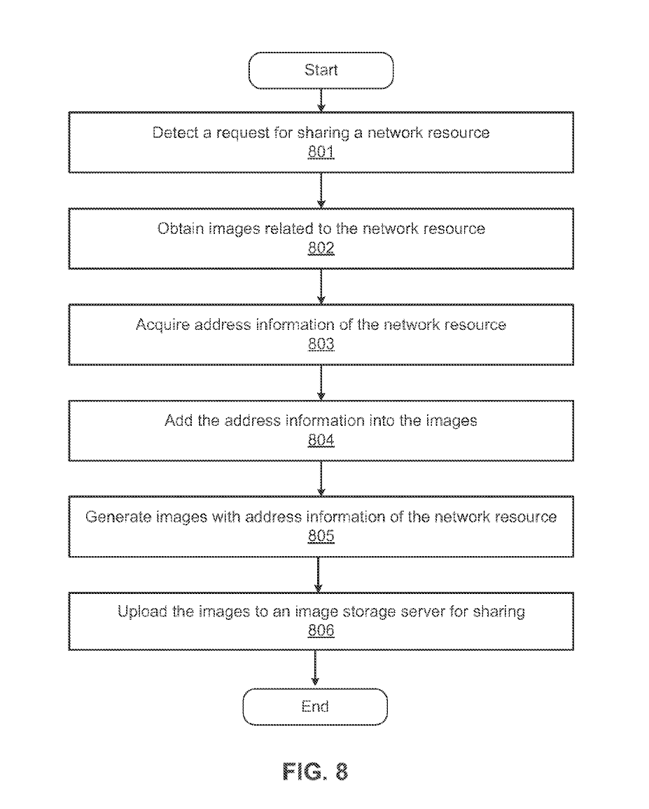

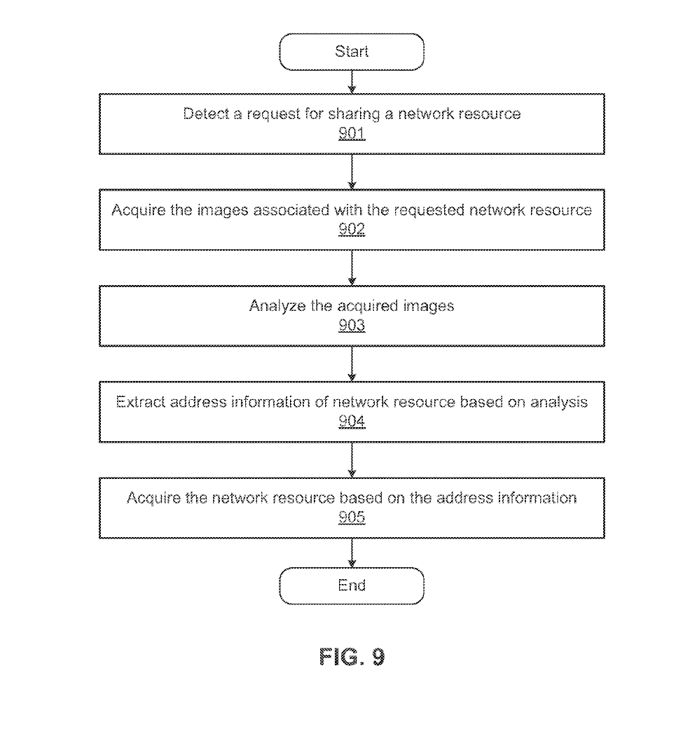

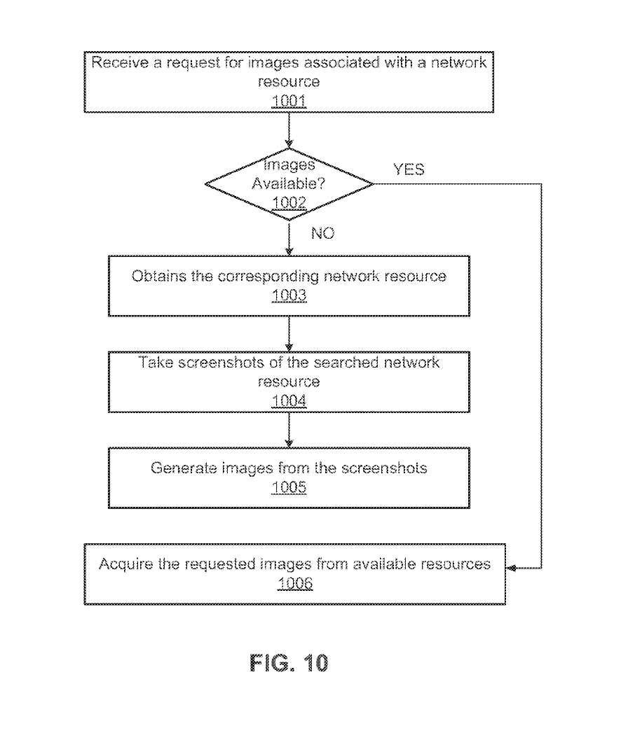

FIG. 8 is a flowchart illustrating a process for generating images that embed network address of network resources for sharing according to one embodiment. FIG. 9 is a flowchart illustrating a process for acquiring network resources according to one embodiment. FIG. 10 is a flowchart illustrating a process for acquiring images that embed network address of network resources for sharing according to one embodiment. The process illustrated in FIG. 8, FIG. 9 and FIG. 10, respectively, can be done either at the client 101 or at the data sharing server 100 or by a combination of both the client 101 and the data sharing server 100. For simplicity of illustration, assume the processes are performed by the resource sharing module 302 and resource acquisition module 304 of the client 101 illustrated in FIG. 3. In addition, some embodiments may perform the steps in parallel perform the steps in different orders, or perform different steps.

Referring to FIG. 8, initially, the client 101 detects 801 a user request for sharing a network resource and obtains 802 images related to the network resources directly from local storage of the client 110 or from remote image storage, e.g., the cloud storage 104 of the data sharing server 100. Examples of the images of the network resource include video frames of a video files if the network resource is a video. The images can also be screenshots of the network resource.

The client 101 also acquires 803 address information of the network resource. The address information of the network resource describes access point to the network resource. Examples of the address information include a URL link to the network resource hosted by a web server. The client 101 adds 804 the address information into the images by digital watermarking techniques, exploration of data storage of Exif image file formats or composition of address information and the image as described above. The client 101 generates the images that embed the address information of the network resource for sharing.

The client 101 uploads 806 the generated images to an image storage server for sharing. In one embodiment, the step of uploading the generated images for sharing comprises multiple sub-steps. The client 101 uploads the generated images to the network resource image database 108 of the data sharing server 100 through the communication interface of the data. sharing server 100. The data sharing server 100 returns a link address of the stored images to the client 101 where the link address indicates where to retrieve the stored images from the data sharing server 100. Upon receiving the link address of the images of the network resource, the client 101 uploads the link address of the images to the data sharing platform 130 of the data sharing server 100. The data sharing platform 130 retrieves the images of the network resource from the data sharing server 100 according the link address of the images and notifies other clients 101 for sharing the network resource.

FIG. 9 is a flowchart illustrating a process for acquiring network resources according to one embodiment. Initially, the client 101 detects 901 a request for sharing a network resource and acquires 902 the images associated with the requested network resources. The client 101 analyzes 903 the acquired images according to the schemes used to process the images, e.g., digital watermarking and Exif image processing, From the analysis, the client 101 extracts 904 address information of the requested network resource, e.g., a URL link of the network resource. The client 101 acquires 905 (e.g., access and download) the network resource from the location indicated by the address information.

FIG. 10 is a flowchart illustrating a process for acquiring images that embed network address of network resources for sharing according to one embodiment. Initially, the client 101 receives 1001 a user request for images associated with a network resource. The client 101 determines 1002 whether the requested images are available locally at the client 101 or remotely at the data sharing server 100. In one embodiment, the client 101 searches the local storage of the client 101 and remote storage of the data sharing server 100. Responsive to the images being available either locally or remotely, the client 101 acquires 1006 the requested images from the available resources. Responsive to the requested images not available, the client 101 obtains 1003 the corresponding network resource from a network resource, e.g., the external data source 102. The client 101 takes 1004 one or more screenshots of the network resource, e.g., video frames captured while viewing a video, and generates 1005 images of the network resource from the screenshots.

The enhanced data sharing system advantageously provides a new channel for sharing network resources by using digital images associated with the network resources. The digital images of the network resources embed network address of the network resources for sharing and the digital images can be used as download access points. Using digital images of the network resources embedding network address of the network resources improves the performance of network resources downloading by securely and efficiently sharing the network address of the network resources to be downloaded.

### GENERAL

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

The above description is included to illustrate the operation of the preferred embodiments and is not meant to limit the scope of the invention. The scope of the invention is to be limited only by the following claims. From the above discussion, many variations will he apparent to one skilled in the relevant art that would yet be encompassed by the spirit and scope of the invention.

1. A computer-implemented method for sharing a digital data resource among a plurality of clients, the method comprising:
detecting a request from a client for sharing the digital data resource identified by the client;
obtaining a digital image associated with the digital data resource identified in the request;
processing the digital image to embed address information of the digital data resource in the processed digital image, wherein other clients of the plurality of clients can access the digital data resource at an address specified by the address information; and
providing the processed digital image associated with the digital data resource to a data sharing platform shared by the plurality of clients.

2. The method of claim 1, further comprising:
acquiring the address information of the digital data resource.

3. The method of claim 1, further comprising:
providing a response to the request from the client, wherein the response indicates that the processed digital image embedding the address information of the digital data resource has been uploaded to the data sharing platform.

4. The method of claim 1, wherein embedding the address information of the digital data resource in the digital image comprises:
applying a digital watermark to the digital image, the digital watermark containing the address information.

5. The method of claim 4, wherein applying the digital watermark to the digital image comprises:
embedding the address information in a least significant bit of a color component of the digital image.

6. The method of claim 1, wherein the digital image is in an exchangeable image file format, and embedding the address information in the digital image comprises:
adding the address information to an extended field of the digital image.

7. The method of claim 1, wherein obtaining a digital image associated with the digital data resource comprises:
searching fur the digital image in local storage of the client; and
responsive to no digital image being found in the local storage of the client, searching for the digital image in remote storage.

8. The method of claim 1, wherein obtaining a digital image associated with the digital data resource comprises:
taking a screenshot of the digital data resource, the screenshot of the digital data resource representing the digital data resource captured at a time point while the digital data resource being displayed; and
generating the digital image from the screenshot of the network resource.

9. The method of claim 1, wherein the data sharing platform comprises at least one of the following:
a microblogging site;
an electronic mailing system;
an instant messaging system;
an online chat forum;
an online group community; and
a virtual network space.

10. The method of claim 1, wherein the digital data resource comprises at least one of the following:
a digital video file;
a computer program file;
an audio file:
a text file; and
a combination of digital audio and digital video data.

11. A client device for sharing a digital data resource among a plurality of clients comprising:
a computer processor for executing computer program modules; and
a non-transitory computer readable storage device storing computer program modules executable to perform steps comprising:
detecting a request from a client for sharing the digital data resource identified by the client;
obtaining a digital image associated with the digital data resource identified in the request;
processing the digital image to embed address information of the digital data resource in the processed digital image, wherein other clients of the plurality of clients can access the digital data resource at an address specified by the address information; and
providing the processed digital image associated with the digital data resource to a data sharing platform shared by the plurality of clients.

12. The device of claim 11, wherein the computer program modules are executable to perform steps comprising:
acquiring the address information of the digital data resource.

13. The device of claim 11, wherein the computer program modules are executable to perform steps comprising:
providing a response to the request from the client, wherein the response indicates that the processed digital image embedding the address information of the digital data resource has been uploaded to the data sharing platform.

14. The device of claim 11, wherein embedding the address information of the digital data resource in the digital images comprises:
applying a digital watermark to the digital image, the digital watermark containing the address information.

15. The device of claim 14, wherein applying the digital watermark to the digital image comprises:
embedding the address information in a least significant hit of a color component of the digital image.

16. The device of claim 11, wherein the digital image is in an exchangeable image file format, and embedding the address information in the digital image comprises:
adding the address information to an extended field of the digital image.

17. The device of claim 11, wherein obtaining a digital image associated with the digital data resource comprises:
searching for the digital image in local storage of the client; and
responsive to no digital image being found in the local storage of the client, searching for the digital image in remote storage.

18. The device of claim 11, wherein obtaining a digital image associated with the digital data resource comprises:
taking one screenshot of the digital data resource, the screenshot of the digital data resource representing the digital data resource captured at a tune point while the digital data resource being displayed; and
generating the digital image from the screenshot of the network resource.

19. The device of claim 11, wherein the data sharing platform comprises at least one of the following:
a microblogging site;
an electronic mailing system;
an instant messaging system;
an online chat forum;
an online group community; and
a virtual network space.

20. The device of claim 11, wherein the digital data resource comprises at least one of the a digital video file;
a computer program file;
an audio file;
a text file; and
a combination of digital audio and digital video data.

21. A non-transitory computer readable medium storing executable computer program instructions for sharing a digital data resource among a plurality of clients, the computer program instructions comprising instructions for:
detecting a request from a client for sharing the digital data resource identified by the client;
obtaining a digital image associated with the digital data resource identified in the request;
processing the digital image to embed address information of the digital data resource in the processed digital image, wherein other clients of the plurality of clients can access the digital data resource at an address specified by the address information; and
providing the processed digital image associated with the digital data resource to a data sharing platform shared by the plurality of clients.

22. The computer-readable storage medium of claim 21, further comprising computer program instructions for:
acquiring the address information of the digital data resource.

23. The computer-readable storage medium of claim 21, further comprising computer program instructions for:
providing a response to the request from the client, wherein the response indicates that the processed digital image embedding the address information of the digital data resource has been uploaded to the data sharing platform.

24. The computer-readable storage medium of claim 21, wherein the computer program instructions for embedding the address information of the digital data resource in the digital images comprise instructions for:
applying a digital watermark to the digital image, the digital watermark containing the address information.

25. The computer-readable storage medium of claim 24, wherein the computer program instructions for applying the digital watermark to the digital image comprise instructions for:
embedding the address information in a least significant bit of a color component of the digital image.

26. The computer-readable storage medium of claim 21, wherein the digital image is in an exchangeable image file format, and the computer program instructions for embedding the address information in the digital image comprise instructions for:
adding the address information to an extended field of the digital image.

27. The computer-readable storage medium of claim 21, wherein the computer program instructions for obtaining a digital image associated with the digital data resource comprise instructions for:
searching for the digital image in local storage of the client; and
responsive to no digital image being found in the local storage of the client, searching for the digital image in remote storage.

28. The computer-readable storage medium of claim 21, wherein the computer program instructions for obtaining a digital image associated with the digital data resource comprise instructions for:
taking a screenshot of the digital data resource, the screenshot of the digital data resource representing the digital data resource captured at a time point while the digital data resource being displayed; and
generating the digital image from the screenshot of the network resource.

29. The computer-readable storage medium of claim 21, wherein the data sharing platform comprises at least one of the following:
a microblogging site;
an electronic mailing system;
an instant messaging system;
an online chat forum;
an online group community; and
a virtual network space.

30. The computer-readable storage medium of claim 21, wherein the digital data resource comprises at least one of the following:
a digital video file;
a computer program file;
an audio file;
a text file; and
a combination of digital audio and digital video data.
